(19) United States
(12) Patent Application Publication
(10) Pub. No.: US 2024/0169084 A1
(43) Pub. Date: May 23, 2024

(54) SOFTWARE-DEFINED CONTROL OF SERVICE ACCESS IN DISTRIBUTED SYSTEMS

(71) Applicant: MESSAGEBIRD BIDCO B.V., Amsterdam (NL)

(72) Inventors: Dana Majid, Amsterdam (NL); Robert Vis, Amsterdam (NL)

(21) Appl. No.: 18/514,766

(22) Filed: Nov. 20, 2023

Related U.S. Application Data
(60) Provisional application No. 63/426,836, filed on Nov. 21, 2022.

(51) Int. Cl. G06F 21/62

(52) U.S. Cl. CPC G06F 21/6218

(57) ABSTRACT

A distributed computer system implements a large-scale message processing system that can initiate, request sending, and monitor the transmission of messages using any of a plurality of different communication channels that are independent of the system. Users can digitally create and store one or more data policies that specify geographical regions, or groups of regions, in which data relating to message flows must reside. Data policies can be associated with or bound to workspace identifiers. When a node of the message processing system receives a client request to process a message, the node first accesses a global hash map storage layer from which data policies can be obtained and selects a region based upon a workspace identifier carried in the client request. The node uses the selected region to forward the client request to service nodes within the specified region for further processing and includes a region identifier in the forwarded request. Users can digitally create and store access policies that specify limits or controls on access to resources. Access policies can be associated with or bound to roles, which can have bindings to users and/or access keys. When a node of the message processing system receives a client request to process a message, the node first accesses a global hash map storage layer from which access policies can be obtained, and selects an access policy based upon a workspace identifier and/or an access key carried in the client request. The node forwards the access policy, or attributes of the access policy, to service nodes if the client is allowed to use the service nodes under the access policy. Each service node conforms to the access policy and blocks the client request from access or using resources that are disallowed according to the policy. Service-to-service requests for further processing also include the access policy or attributes. Complex structured representations of access policies can be flattened into permissions trees for storage in tables of a relational database system or in flat file tables to enable rapid, wire-speed lookups and evaluation of access policies in real-time as messages traverse the system.

### COPYRIGHT NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright or rights whatsoever. © 2022 MessageBird B.V.

### TECHNICAL FIELD

One technical field of the present disclosure is automated control of data storage in distributed or virtual digital data storage systems. Another technical field is automated control of programmatic access to networked application services in distributed systems. Another technical field is large-scale distributed computer systems that are programmed to operate as short message transmission systems.

### BACKGROUND

The approaches described in this section are approaches that could be pursued, but not necessarily approaches that have been previously conceived or pursued. Therefore, unless otherwise indicated, it should not be assumed that any of the approaches described in this section qualify as prior art merely by virtue of their inclusion in this section.

Large-scale distributed computer systems have entered wide use to support the transmission of short text messages, instant message services, verification messages, and other applications. With these systems, enterprises can define flows of messages via Short Message Service (SMS), MMS, WHATSAPP, other instant messengers, and other communication channels such as chat services. Flows can specify conversations across multiple different communication channels, verification via two-factor authentication, or other services or applications. The core operating software of the messaging systems, which implement state machines to define transitions from one message state to another, can facilitate large numbers of flows for many enterprises at once.

These systems and their core operating software offer tremendous flexibility and scalability but have suffered from two drawbacks. First, institutional users or customers of the systems may require storing digital data only in a particular geographic region, for purposes of complying with legal regimes, load balancing, fast execution, or other reasons. Second, because service providers often charge fees based upon the volume of use of applications or services, users or customers need to control which users have programmatic access to particular services. However, existing large-scale messaging systems have not provided convenient or simple means for enterprises and non-technical personnel to define and enforce data residency requirements or define and enforce service access controls. There is a long-standing, unmet need in the field for improved ways of introducing control logic for these purposes into messaging services that use distributed, virtualized computing resources.

### SUMMARY

The appended claims may serve as a summary of the invention.

### BRIEF DESCRIPTION OF THE DRAWINGS

In the drawings:

FIG. 1 illustrates a distributed computer system showing the context of use and principal functional elements with which one embodiment could be implemented.

FIG. 2A schematically illustrates a distributed computer system organized using regional processors and load balancers, in an arrangement of one possible embodiment.

FIG. 2B schematically illustrates a regional domain of a distributed computer system in an arrangement of one possible embodiment.

FIG. 2C illustrates the functional elements of FIG. 2A, FIG. 2B that interoperate in a data flow providing software-defined enforcement of one or more requirements in an arrangement of one possible embodiment.

FIG. 3 illustrates an example process flow that can be programmed to implement data residency control in a message processing system.

FIG. 4A illustrates an example data flow that can be used in one embodiment of defining distributed service access controls.

FIG. 4B illustrates an example process flow that can be programmed to implement distributed service access control in a message processing system.

FIG. 5 illustrates a computer system with which one embodiment could be implemented.

### DETAILED DESCRIPTION

In the following description, for the purposes of explanation, numerous specific details are set forth in order to provide a thorough understanding of the present invention. It will be apparent, however, that the present invention may be practiced without these specific details. In other instances, well-known structures and devices are shown in block diagram form in order to avoid unnecessarily obscuring the present invention.

The text of this disclosure, in combination with the drawing figures, is intended to state in prose the algorithms that are necessary to program a computer to implement the claimed inventions, at the same level of detail that is used by people of skill in the arts to which this disclosure pertains to communicate with one another concerning functions to be programmed, inputs, transformations, outputs and other aspects of programming. That is, the level of detail set forth in this disclosure is the same level of detail that persons of skill in the art normally use to communicate with one another to express algorithms to be programmed or the structure and function of programs to implement the inventions claimed herein.

Embodiments are described in the sections below according to the following outline:
1. General Overview
2. Structural & Functional Overview
   2.1 Message Application Processor and Environment
   2.2 Software-Defined Control of Data Residency
   2.3 Software-Defined Control of Programmatic Access to Services
   2.4 Practical Applications
3. Implementation Example—Hardware Overview

### 1. General Overview

A distributed computer system implements a large-scale message processing system that can initiate, request sending, and monitor the transmission of messages using any of a plurality of different communication channels that are independent of the system. Different users, entities, or enterprises, including those having a customer relationship with an owner or operator of the message processing system, operate independent applications that can call the message processing system to request the system to originate or publish messages on any one or more of the channels. Users or enterprises can control message flows, data storage, and access in at least two ways. First, users can digitally create and store one or more data policies that specify geographical regions, or groups of regions, in which data relating to message flows must reside. Data policies can be associated with or bound to workspace identifiers. When a node of the message processing system receives a client request to process a message, the node first accesses a global hash map storage layer from which data policies can be obtained and selects a region based upon a workspace identifier carried in the client request. The node uses the selected region to forward the client request to service nodes within the specified region for further processing and includes a region identifier in the forwarded request. Those service nodes observe the region identifier and are programmed to access and store data only using virtual storage instances or data storage devices that are within the specified region. Service-to-service requests for further processing also include the region identifier.

Second, users can digitally create and store one or more access policies that specify limits or controls on access to resources. Access policies can be associated with or bound to roles, which can have bindings to users and/or access keys. When a node of the message processing system receives a client request to process a message, the node first accesses a global hash map storage layer from which access policies can be obtained and selects an access policy based upon a workspace identifier and/or an access key carried in the client request. The node forwards the access policy, or attributes of the access policy, to service nodes if the client is allowed to use the service nodes under the access policy. Each service node conforms to the access policy and blocks the client request from accessing or using resources that are disallowed according to the policy. Service-to-service requests for further processing also include the access policy or attributes. Complex structured representations of access policies can be flattened into permissions trees for storage in hash map storage layers, tables of a relational database system, or in flat file tables to enable rapid, wire-speed lookups and evaluation of access policies in real-time as messages traverse the system.

For purposes of illustrating a clear example, certain sections of this disclosure use terminology and describe processes that are specific to SMS messaging. However, other embodiments may implement voice calling, voice messaging, email transfer, and messaging using applications, apps, or platforms other than SMS, through similar calls, objects, formats, processes, and operations.

In various embodiments, the disclosure encompasses the subject matter of the following numbered clauses:
1. A computer-implemented method, comprising: using a message processing system, receiving and digitally storing a plurality of structured data policy definitions that correspond to data policies, each of the data policy definitions comprising one or more region identifiers of one or more geographic regions, each of the data policy definitions being stored, in a virtual storage instance, in association with a first workspace identifier from among a plurality of different workspace identifiers; using the message processing system, receiving a service request from a client computer, the service request comprising a second workspace identifier, and in response to the request, the message processing system accessing the virtual storage instance to read a particular data policy corresponding to the second workspace identifier; the message processing system selecting, from the particular data policy, a particular region identifier of a particular geographic region; forwarding the service request only to a service instance that is within the particular geographic region; using the service instance, executing one or more data read operations and/or data write operations using only one or more virtual storage instances that are within the region corresponding to the region identifier.
2. The method of clause 1, further comprising storing the plurality of structured data policy definitions in a first global hash map storage layer of the virtual storage instance.
3. The method of clause 2, the message processing system comprising at least an edge processor, a public application load balancer that is communicatively coupled to the edge processor and to a plurality of service instances, each of the service instances being hosted or executed using a virtual compute instance, each of the service instances being communicatively coupled to a second global hash map storage layer and a local hash map storage layer, the first global hash map storage layer being communicatively coupled to the edge processor; the method further comprising: receiving the service request from the client computer at the edge processor; the edge processor reading the particular data policy corresponding to the second workspace identifier from the first global hash map storage layer; the edge processor forwarding the service request to the public application load balancer with a new header comprising the particular region identifier, the public application load balancer being within the particular geographic region.
4. The method of clause 3, further comprising the edge processor selecting, from the particular data policy, the particular region identifier of a particular geographic region.
5. The method of clause 3, further comprising one of the service instances executing one or more data read operations and/or data write operations associated with the request, using only virtual storage instance(s) within the region corresponding to the region identifier.
6. The method of clause 3, further comprising a first service instance among the plurality of service instances forwarding the request to a second service instance among the plurality of service instances, as a forwarded request, and including the region identifier of the selected region in the forwarded request.
7. The method of clause 1, each of the structured data policy definitions comprising at least a first declaration of a group and a second declaration of one or more geographic regions in the group, each second declaration comprising a priority value in association with an identification of the one or more geographic regions.
8. The method of clause 7, further comprising the message processing system selecting, from the particular data policy, the particular region identifier of the particular geographic region based on the priority value of the particular geographic region.
9. The method of clause 1, further comprising, as part of the executing, selecting a particular communication channel among a plurality of different communication channels, and transmitting a request to the particular communication channel to transmit a message using the particular communication channel.
10. The method of clause 9, the plurality of different communication channels comprising two or more of SMS; MMS; WHATSAPP; FACEBOOK MESSENGER; WEIXIN/WECHAT; QQ; TELEGRAM; SNAPCHAT; SLACK; SIGNAL; SKYPE; DISCORD; VIBER.
11. A computer-implemented method, comprising: using a message processing system, receiving and digitally storing a plurality of structured service access policy definitions that correspond to data policies, each of the service access policy definitions comprising at least a policy name, a resource identifier, and an action that is allowed or disallowed on the resource, each of the access policy definitions being associated with a first access key, each of the service access policy definitions being stored in a virtual storage instance; using the message processing system, receiving a service request from a client computer, the service request comprising a second access key, and in response to the request, the message processing system accessing the virtual storage instance to read a particular service access policy corresponding to the second access key; the message processing system forwarding the service request to a service instance only when the particular service access policy corresponding to the second access key of the service request allows the client computer or a user thereof to access the service instance.
12. The method of clause 11, further comprising storing the plurality of structured service access policy definitions in a first global hash map storage layer of the virtual storage instance.
13. The method of clause 12, the message processing system comprising at least an edge processor, a public application load balancer that is communicatively coupled to the edge processor and to a plurality of service instances, each of the service instances being hosted or executed using a virtual compute instance, each of the service instances being communicatively coupled to a second global hash map storage layer and a local hash map storage layer, the first global hash map storage layer being communicatively coupled to the edge processor; the method further comprising: receiving the service request from the client computer at the edge processor; the edge processor reading the particular service access policy corresponding to the second workspace identifier from the first global hash map storage layer; the edge processor forwarding the service request to the public application load balancer with a new header comprising the particular service access policy corresponding to the second workspace identifier.
14. The method of clause 11, each of the service access policy definitions comprising at least a policy name, a resource identifier, and an action that is allowed or disallowed on one or more API calls, methods, functions, virtual storage instances or other resources.
15. The method of clause 13, each of the service access policy definitions comprising at least a policy name, a resource identifier, and an action that is allowed or disallowed on one or more API calls, methods, functions, virtual storage instances or other resources.
16. The method of clause 15, further comprising a first service instance among the plurality of service instances executing one or more functions, services, data read operations and/or data write operations associated with the request using only API calls, methods, functions, virtual storage instances or other resources that the client computer or a user thereof is allowed to access based on the particular service access policy.
17. The method of clause 15, further comprising a first service instance among the plurality of service instances forwarding the request to a second service instance among the plurality of service instances, as a forwarded request, only when the particular service access policy corresponding to the second access key of the service request allows the client computer or a user thereof to access the second service instance, and including the particular service access policy in the forwarded request.
18. The method of clause 17, further comprising the message processing system selecting, from the particular service access policy, the particular region identifier of the particular geographic region based on the priority value of the particular geographic region.
19. The method of clause 16, further comprising, as part of the executing, selecting a particular communication channel among a plurality of different communication channels, and transmitting a request to the particular communication channel to transmit a message using the particular communication channel.
20. The method of clause 19, the plurality of different communication channels comprising two or more of SMS; MMS; WHATSAPP; FACEBOOK MESSENGER; WEIXIN/WECHAT; QQ; TELEGRAM; SNAPCHAT; SLACK; SIGNAL; SKYPE; DISCORD; VIBER.

### 2. Structural & Functional Overview

### 2.1 Message Application Processor and Environment

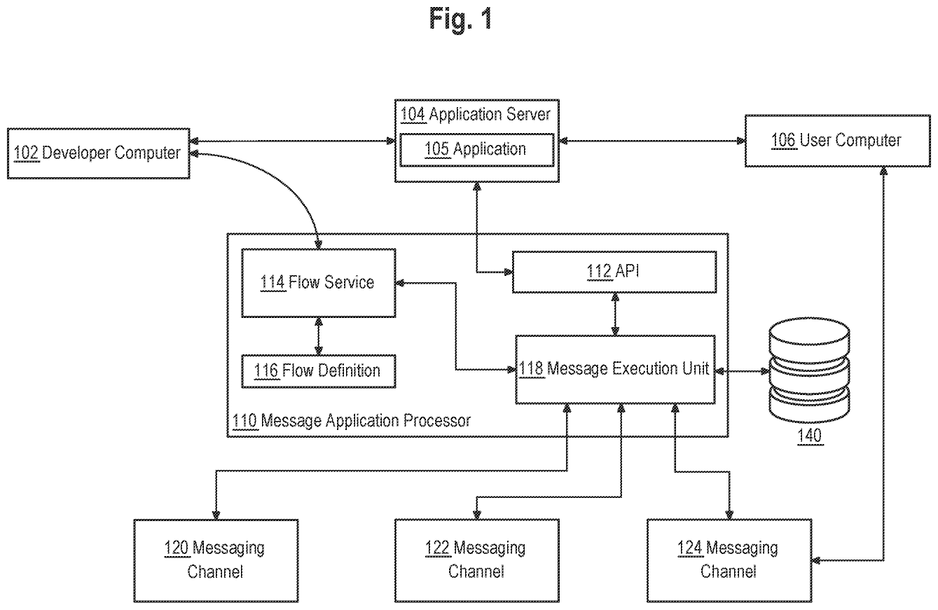

FIG. 1 illustrates a distributed computer system showing the context of use and principal functional elements with which one embodiment could be implemented. In an embodiment, a computer system of FIG. 1 comprises components that are implemented at least partially by hardware at one or more computing devices, such as one or more hardware processors executing stored program instructions stored in one or more memories for performing the functions that are described herein. In other words, all functions described herein are intended to indicate operations that are performed using programming in a special-purpose computer or general-purpose computer, in various embodiments. FIG. 1 illustrates only one of many possible arrangements of components configured to execute the programming described herein. Other arrangements may include fewer or different components, and the division of work between the components may vary depending on the arrangement.

FIG. 1, and the other drawing figures and all of the description and claims in this disclosure, are intended to present, disclose, and claim a technical system and technical methods in which specially programmed computers, using a special-purpose distributed computer system design, execute functions that have not been available before to provide a practical application of computing technology to the problem of machine learning model development, validation, and deployment. In this manner, the disclosure presents a technical solution to a technical problem, and any interpretation of the disclosure or claims to cover any judicial exception to patent eligibility, such as an abstract idea, mental process, method of organizing human activity, or mathematical algorithm, has no support in this disclosure and is erroneous.

In the example of FIG. 1, a developer computer 102 is communicatively coupled, directly or indirectly via one or more networks or network links, to an application server 104, which is also coupled to a message application processor 110 and to a user computer 106. The message application processor 110 is coupled to a plurality of different messaging channels 120, 122, 124. Lines and arrows joining the developer computer 102, application server 104, message application processor 110, user computer 106, and messaging channels 120, 122, 124 broadly represent any combination of one or more local area networks, wide area networks, campus networks, or internetworks, using any of terrestrial or satellite links and/or wired or wireless network links.

Generally, in this arrangement, developer computer 102 is associated with a developer, owner, or operator of an interactive, online computer program application 105 that application server 104 executes. The developer computer 102 provides programming, configuration, testing, and maintenance concerning one or more applications 105 that execute at application server 104. User computer 106 interacts with the application server 104 to obtain a substantive service, such as a merchant service, online shopping service, financial service, entertainment or game service, educational service, or any other substantive application. Application server 104 can implement or host an HTTP server to facilitate delivering dynamic HTML applications to clients such as user computer 106 and to accomplish parameterized HTTP GET and POST calls to message application processor. Application server 104 can implement an SMS handler for inbound (received) SMS messages using the POST HTTP method. Message application processor 110 originates messages to the user computer 106 via messaging channels 120, 122, 124, on behalf of the application server 104 and its applications 105.

Each of the developer computer 102 and user computer 106 can have the structure shown for a general-purpose computer in FIG. 6 and can be any of a laptop computer, desktop computer, workstation, or mobile computing device, in various embodiments. Application server 104 and/or message application processor 110 can be implemented using one or more server computers, processor clusters, and/or virtual computing instances in any of an enterprise data room, private data center, or public data center such as a cloud computing facility. Typically, the application server 104 and message application processor 110 are implemented using flexible cloud computing services with which processors, memory, and storage with different numbers, sizes, or capacities can be instantiated based on processing demand or number of clients.

The messaging channels 120, 122, 124 represent message networks, applications, or services, and typically are independent of the message application processor 110. “Channel,” in this context, refers broadly to a message service provider, all its independent infrastructure, and its software applications, application programming interfaces, and related services. Examples of channels include, as of this writing: SMS; MMS; WHATSAPP; FACEBOOK MESSENGER; WEIXIN/WECHAT; QQ; TELEGRAM; SNAPCHAT; SLACK; SIGNAL; SKYPE; DISCORD; VIBER. The messaging channels 120, 122, 124 also can represent a mail transfer agent (MTA) integrated into the message application processor 110 or external, for sending electronic mail (email). The messaging channels 120, 122, 124 also can include any message service, system, software, application, or app that is functionally equivalent to one or more of the foregoing and developed after the time of this writing.

In one embodiment, message application processor 110 comprises an application programming interface (API) 112, flow service 114, and message execution unit 118. Each of the API 112, flow service 114, and message execution unit 118 can be implemented using one or more sequences of computer program instructions, methods, functions, objects, or other units of program instructions. API 112 can be implemented as a Representational State Transfer (REST) API having a set of function calls that can be invoked programmatically from an application executing at application server 104. For example, application 105 can format and transmit an HTTP GET or POST request specifying API 112 as an endpoint and having a parameterized payload that identifies a particular API call and values for use in processing the call. When creating a message is requested, the API automatically assigns a unique random identifier value so that applications can always check the status of the message using the API and the ID. API 112 can be integrated with an HTTP server and can be programmed to return an HTTP response to each API call that includes a payload with responsive values. API 112 can implement security controls based on access keys for authorization; for example, an owner or operator of the message application processor 110 securely generates an API key for the particular application 105 of the owner or operator of the application server and/or developer computer 102 and provides the API key to the developer computer. The application 105 is programmed to present the API key to the API 112 with each API call to authenticate the call and, as described in other sections, to enable associating flow definitions 116 with message state transitions for messages that are associated with the application. Requests and response payloads can be formatted as JSON using UTF-8 encoding and URL-encoded values.

Flow service 114 can be programmed to implement flow definition or authoring functions, and flow evaluation functions. In an embodiment, developer computer 102 can establish a connection to the flow service 114 for the purpose of authoring or defining a flow definition 116 (also termed a “flow”) that defines one or more message states or state transitions, and one or more instructions, calls, or other logic to be executed for messages having a particular state or state transition. In an embodiment, flow service 114 implements a visual, graphical user interface by which flows can be defined visually using a pointing device of the developer computer 102 to move or place graphical objects representing states, transitions, calls, or services.

Message execution unit 118 represents instructions that implement core message processing functions of the message application processor 110 such as message publishing services, interfaces to messaging channels 120, 122, 124, exception handling, and analytical reports. Message execution unit 118 can be programmed to create, read, update, or delete messages, message metadata, and control metadata in a database 140, which can be implemented using any of relational databases, no-SQL databases, object stores, or other data repositories. The programming and operation of message execution unit 118 are described further in other sections herein. A commercial embodiment of message application processor 110 is the MESSAGEBIRD message processing system of MessageBird B.V., Amsterdam, Netherlands.

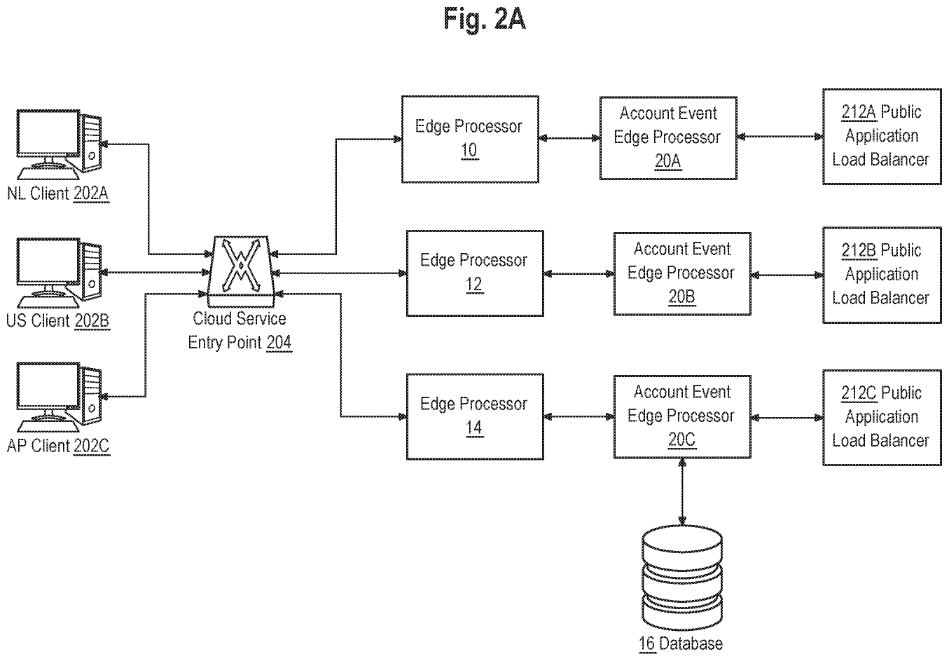

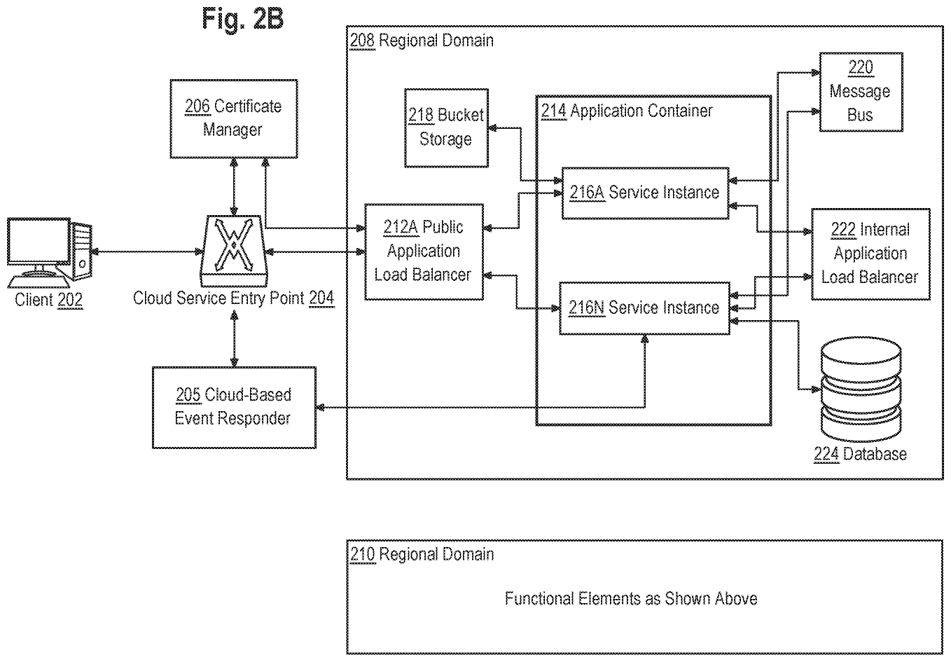

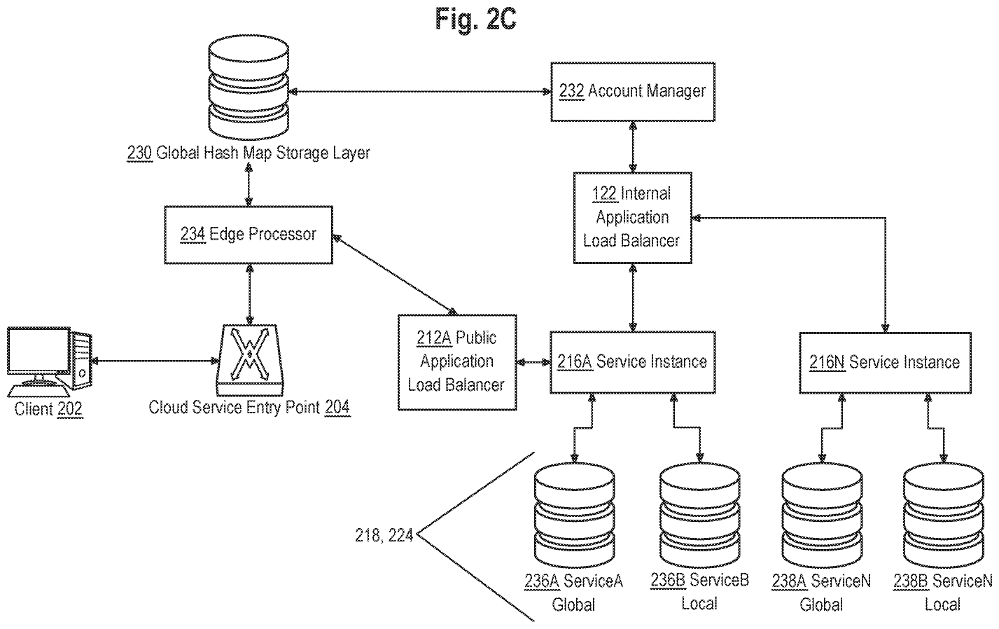

In some embodiments, message application processor 110 can be implemented using a distributed computing system comprising a plurality of virtual compute instances and virtual storage instances in a private data center or a commercial, public cloud computing service such as AMAZON AWS, MICROSOFT AZURE, or GOOGLE CLOUD. In such a deployment, the functional elements of message application processor 110, application server 104, and database 140 can be distributed across multiple different virtual compute instances and storage instances, organized in different physical, and geographic regions, with access mediated using load balancers and other networking infrastructure. FIG. 2A schematically illustrates a distributed computer system organized using regional processors and load balancers, in an arrangement of one possible embodiment. FIG. 2B schematically illustrates a regional domain of a distributed computer system in an arrangement of one possible embodiment. FIG. 2C illustrates the functional elements of FIG. 2A, FIG. 2B that interoperate in a data flow providing software-defined enforcement of one or more requirements in an arrangement of one possible embodiment. FIG. 2A, FIG. 2B, FIG. 2C collectively illustrate different logical views of topologies or architectures of distributed computing elements that can be deployed and connected to enable access to and use of messaging system like FIG. 1 in a widely geographically distributed virtual computing system.

Referring first to FIG. 2A, in an embodiment, a plurality of client computers 202A, 202B, 202C are communicatively coupled to a cloud service entry point 204. Each of the client computers 202A, 202B, 202C can have the structure of user computer 106 (FIG. 1). For purposes of illustrating a clear example, the client computers 202A, 202B, 202C are located in different geographical locations such as the Netherlands, United States, and an Asia-Pacific location, as indicated by the labels NL, US, and AP in FIG. 2A. Other embodiments could use any number of client computers located in any geography. Cloud service entry point 204 can comprise a content delivery network, or a virtual compute instance that provides access to the same, associated with a commercial virtual compute and virtual storage networking system; commercial examples include Microsoft Azure DevOps server, Amazon, Cloudflare, and BelugaCDN.

Cloud service entry point 204 is communicatively coupled to a plurality of edge processors 10, 12, 14, each of which is serially coupled respectively to an account event edge processor 20A, 20B, 20C, then to a public application load balancer 212A, 212B, 212C. Edge processors 10, 12, 14 can be implemented as API gateways, and account event edge processors 20A, 20B, 20C can be edge computing environments such as Azure Functions, Google App Engine, Red Hat, OpenShift, Salesforce Heroku, and Amazon. Each of the account event edge processors 20A, 20B, 20C can be coupled in a private network to one or more instances of the message application processor 110 (FIG. 1), which is omitted from FIG. 2A for clarity. Account event edge processor 20C, and others, can be communicatively coupled to a database 16 that stores metadata relating to data residency controls or access controls.

In an embodiment, each of the edge processors 10, 12, 14 is located in and associated with a different geographical region of the world. Examples of regions include the European Union, United States, and Asia-Pacific. Regions can be associated with a unit or area of a region, continent, or country; examples include US-east, EU-west, etc. Edge processors 10, 12, 14 can have names or labels that identify their locations, such as us-east-1, eu-west-1, ap-southeast-1, and so forth.

The arrangement of FIG. 2A facilitates the enforcement of data residency controls for client requests. As described herein in other sections, clients 202A, 202B, 202C can programmatically transmit requests to application services, such as instances of message application processor 110, the requests specifying one or more regions or one or more groups of regions. Requests from clients of all geographies arrive at cloud service entry point 204, which is programmed to forward the requests to an edge processor 10, 12, 14 located in a geography or domain corresponding to the location of the requesting clients. Cloud service entry point 204 can be programmed to select the correct edge processor 10, 12, 14 based on metadata in a request, such as a location identifier of the client, an origin country value, or by executing a geolocation lookup using a source IP address of the client using a third-party service or a native database that maps the network part of the IP address to a country, region, or geography.

An edge processor 10, 12, 14, in response to receiving a request, forwards the request to a corresponding account edge processor 20A, 20B, 20C. A request will additionally include a workspace identifier and an access key. Based on these values, the receiving account edge processor can be programmed to query the database 16 to validate group or region data carried in the request, to confirm that the request is authorized to interoperate with compute elements and/or storage elements in the specified group or region data. Further, the account edge processor 20A, 20B, 20C that receives a request can be programmed to select a particular region from among a plurality of regions that are specified in the request and to forward the request to a public application load balancer 212A, 212B, 212C that is in an allowed region. The account edge processor 20A, 20B, 20C that receives a request also is programmed to include the same group and region data in a forwarded request, to propagate the values to downstream elements.

Referring now to FIG. 2B, in one embodiment, client 202 is communicatively coupled to cloud service entry point 204, which is coupled to public application load balancer 212A in a first regional domain 208. Thus, in FIG. 2B, other clients of FIG. 2A, edge processors, and account event edge processors are omitted for clarity, and to enable showing other relevant functional elements of the embodiment. Regional domain 208 may comprise functional elements all located in a particular geography, such as the European Union, US, Africa-Middle East, Asia-Pacific, and so forth, and can be distinct from one or more other regional domains 210 having similar internal architecture of functional elements all located in a different geography.

The cloud service entry point 204 can be coupled to a certificate manager 206 and a cloud-based event responder 205. In an embodiment, certificate manager 206 is programmed to manage digital certificates for functional elements of the regional domain 208, and to respond to requests of client 202 to establish secure connections to those functional elements. The cloud-based event responder 205 can be implemented using Engine, Red Hat, OpenShift, Salesforce Heroku, and Amazon.

In an embodiment, the regional domain 208 comprises one or more virtual compute instances and virtual storage instances that host an application container 214 in which one or more service instances 216A, 216N execute. Each of the service instances 216A, 216N can implement the same substantive application or service, or different applications or services. The designation “N” for service instance 216N connotes that application container 214 can host or execute any number of service instances, and two are shown in FIG. 2B solely to illustrate a clear example. Application container 214 can use DOCKER, KUBERNETES, or other containerization technology. Each of the service instances 216A, 216N can implement the message application processor 110, or applications or services associated with it. One or more of the service instances 216A, 216N can be communicatively coupled to bucket storage 218, such as an AMAZON S3 instance, for high-speed, high-availability storage of data to support substantive service functions. The service instances 216A, 216N can also be coupled to an internal application load balancer 222, which is programmed to receive requests from one service to use another service or application, and to determine which instance of the other service or application should receive the request based on then-current load data. Each of the service instances 216A, 216N also can be communicatively coupled to a message bus 220 for communication with other services or applications having independent load balancing or not subject to load balancing, and to a database 224. In an embodiment, database 224 is programmed with replication logic to automatically replicate designated global hash map storage layers to database 16 (FIG. 2A).

Referring now to FIG. 2C, while the architectures of FIG. 1, FIG. 2A, FIG. 2B represent a generally complete environment for implementing embodiments, the processes of sections 2.2, 2.3 of this disclosure can be understood more readily by focusing on the elements of FIG. 2C. In an embodiment, client 202 can be communicatively coupled to cloud service entry point 204, which is coupled to edge processor 234, which is coupled to public application load balancer 212A, as in the embodiments of FIG. 2A, FIG. 2B.

The edge processor 234 is coupled to a global hash map storage layer 230 in database 16 (FIG. 2A). In this context, “global” refers to a data repository that receives automatically replicated updates from other databases, tables, or storage. Global hash map storage layer 230, and other data repositories of this disclosure, can be implemented using no-SQL databases, SQL relational databases, REDIS repositories, in-memory storage, AMAZON S3 buckets, and other forms of online digital data storage.

The public application load balancer 212A is also coupled to service instance 216A, which is coupled to an internal application load balancer 122 capable of balancing load concerning service-to-service requests between service instances 216A, 216N, or other services. The internal application load balancer 122 is communicatively coupled to an account manager 232 which can be programmed to mediate requests for data relating to organizations, accounts, and users. Each of the service instances 216A, 216N is coupled to a global hash map storage layer 236A, 238A, respectively, and to a local hash map storage layer 236B, 238B, respectively. The term “hash map storage layer” is used for these elements to illustrate a clear example, but each element denoted a “hash map storage layer” can be a database, table, set of tables, or storage. Global hash map storage layers 306A, 238A are configured to automatically replicate data stored therein to the global hash map storage layer 230. Local hash map storage layers 306B, 238B are configured to receive local data updates that are not replicated. With this architecture, the system can enforce data residency requirements when the local hash map storage layers 306B, 238B are in one geography but the global hash map storage layer 230 is in another.

### 2.2 Software-Defined Control of Data Residency

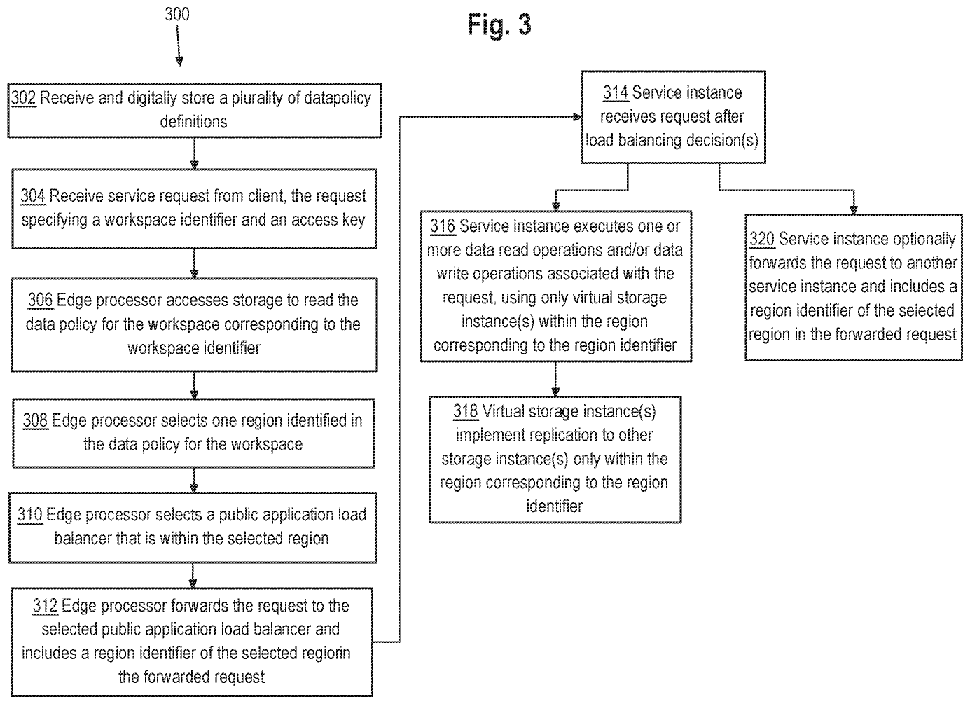

FIG. 3 illustrates an example process flow that can be programmed to implement data residency control in a message processing system. FIG. 3 and each other flow diagram herein is intended as an illustration of the functional level at which skilled persons, in the art to which this disclosure pertains, communicate with one another to describe and implement algorithms using programming. The flow diagrams are not intended to illustrate every instruction, method, object, or sub-step that would be needed to program every aspect of a working program, but are provided at the same functional level of illustration that is typically used at the high level of skill in this art to communicate the basis of developing working programs.

Embodiments are programmed to automatically enforce data residency requirements that users, clients, or customers programmatically declare in configuration data. As described in the Background, users need to select specific regions of the world having digital data storage where their data is to reside. The selection of the correct region can affect legal compliance, response time or latency, and end-user experience or satisfaction. Embodiments enable users to declare where they want their data to reside, and thereafter, throughout the processing of events and requests of clients, the distributed systems of this disclosure are programmed to ensure that residency requirements propagate throughout the software stack and are enforced using individual functional elements.

As one operational example, the message application processor 110 and/or service instance(s) 216A, 216N receive a programmatic request from a client 202 or user computer over a network. In this context, “programmatic request” refers to an API call, HTTP POST request with values in parameters of the URL or in a payload, a remote procedure call, or any other software-implemented means by which one computer can transmit a structured digital message over a network to another computer. In response to receiving a request, a particular service instance 216A, 216N is programmed to determine where to read data or write data, or where to forward the request to another element in a different region that is authorized to create, read, update, or delete data. In an embodiment, each particular service instance 216A, 216N is programmed to determine a data residency region for each request. In an embodiment, each request carries a workspace identifier and an access key. Based on these values, each particular service instance 216A, 216N is programmed to determine a region of choice. Thus, the selection of a region occurs per request and per organization.

Determining a region can comprise requesting and retrieving a data policy comprising a set of declarations of regions or groups of regions, then inspecting the data to select a region specified in the data. In some embodiments, each region or group of regions has a priority value, and each particular service instance 216A, 216N is programmed to select a first region, confirm the region with a load balancer, and select a second or lower-priority region if the load balancer responds that the first region is unavailable or has excessive load. In response to selecting a region, each particular service instance 216A, 216N is programmed to route the request to the region application load balancer of the selected region. Each region application load balancer is programmed to forward the request to a service instance to process the request. Each forwarding operation includes the data policy. Before reading data or writing data, each particular service instance 216A, 216N is programmed to inspect the data policy from the request it received and confirm that the data policy identifies a region or group that contains the data storage device(s) or virtual storage instance(s) that the service instance will use in a create, read, update, or delete operation.

Referring now to FIG. 3, in one embodiment, a data residency enforcement process 300 is programmed at block 302 to receive and digitally store a plurality of data policy definitions. In an embodiment, block 302 comprises a client 202 (FIG. 2C) connecting to a service instance 216A via cloud service entry point 204, edge processor 234, and public application load balancer 212A and requesting a policy editor interface or page in which data policy code can be specified. In response, acting as a policy server, the service instance 216A responds by providing the policy editor page and thereafter processing data input defining a data policy. In some embodiments, the policy editor page can implement a full, GUI-based application development editor with type-ahead functions, syntax checking, and so forth. In other embodiments, the policy editor page can be programmed to receive an upload of a data policy file that contains a code specification that was written or edited using a separate text editor. The term “page” is used for convenience and the specific mechanism by which a client 202 creates a data policy and delivers it to the system is not critical.

Each data policy can be specified using a set of data declarations in a scripting language, declarative language, or other human-readable data serialization language that is capable of machine parsing and interpretation; examples include JSON, YAML, XML, or CSV or tab-delimited data storage. TABLE 1 illustrates an example of a data policy using one particular structured declarative syntax:

TABLE 1
EXAMPLE STRUCTURED DATA POLICY DEFINITION

```
{
  “name”: “string”,
  “description”: “string”,
  “dataPolicy”: {
    “group”: “us-east”,
    “regions”: [{
      “priority”: 0,
      “region”: “us-east-1”
    }, {
      “priority”: 1,
      “region”: “us-east-2”
    }]
  }
}
```

The example of TABLE 1 shows that a data policy can conform to the following format and grammar in an embodiment:
1. A data policy definition comprises a name, a description, and a data policy. In some embodiments, the description can be omitted and the name can be self-describing.
2. A data policy comprises one or more region groups.
3. A region group comprises one or more regions.
4. Each of the regions may be associated with a priority value.

When a functional element retrieves a data policy from storage, for example, to select an available region or group, the response could have the form of TABLE 2:

TABLE 2
DATA POLICY RESPONSE

```
GET /region-groups
{
  “results”: [{
    “name”: “eu-west”,
    “regions”: {“eu-west-1”,”eu-west-2”}
    }, {
    “name”: “us-east”,
    “regions”: {“us-east-1”,”us-east-2”}
    }, {
    “name”: “us-east-1”,
    “regions”: {“us-east-1”}
    }]
}
```

Referring again to FIG. 3, at any time after at least one data policy definition has been stored, at block 304, a request from the client is received. For example, client 202 (FIG. 2C) can transmit a request to an API endpoint that the cloud service entry point 204 proxies or virtualizes. In response, the cloud service entry point 204 forwards the request to the edge processor 234. As stated earlier, each request of client 202 includes at least a workspace identifier and an access key, and usually a request type or name and one or more parameters associated with the request. The workspace identifier uniquely identifies a logical space or domain that is associated with an enterprise, entity, or organization; the message application processor 110 typically creates a first workspace automatically in response to the enterprise, entity, or organization establishing an account with the message application processor. A workspace can match the enterprise, entity, or organization 1:1, or the enterprise, entity, or organization can have multiple workspaces corresponding, for example, to business units, teams, or campaigns.

At block 306, the edge processor accesses storage to read the data policy for the workspace corresponding to the workspace identifier. In one embodiment, edge processor 234 queries the global hash map storage layer 230 to request a data policy based on the workspace identifier and receives, in response, a result set of records or a structured data item like TABLE 2 above. In some embodiments, as further described, structured data items like TABLE 2 can be flattened using an offline process to convert them to a flat table of rows with column attributes. In either case, the response will specify one or more regions or groups of regions.

In response, at block 308, the edge processor selects one region that is identified in the data policy for the workspace. The edge processor 234 can be programmed with selection logic according to a variety of rules. For example, the edge processor can inspect priority values associated with multiple region values in a data policy and select the region that is associated with the highest priority value. Or, the edge processor can initiate requests to load balancers of one or more, or all, the regions identified in the data policy to query the then-current service load of service instances behind those load balancers, then select a region based on the least load. Or, the edge processor can use local memory or global hash map storage layer 230 to store data specifying the most recently selected region, and selected the next region using round-robin logic.

At block 310, the edge processor selects a public application load balancer of the selected region. To make the selection, the edge processor can access topology data or system configuration data in global hash map storage layer 230, or use a routing table stored in the edge processor that maps the addresses of public application load balancers to region identifiers.

At block 312, the edge processor forwards the request to the selected public application load balancer and includes a region identifier of the selected region in the forwarded request. With this step, the edge processor is programmed to pass the region identifier as a context parameter downstream to applications or services at other nodes so those functional elements can use the region identifier for data source configuration. While the selected public application load balancer is necessarily within the selected region, the edge processor cannot guarantee the behavior of downstream nodes unless the region identifier is included. Each application then ensures that it propagates the region identifier to other services if cross-service communication occurs, and uses storage only within the specified region.

For example, at block 314, a service instance receives the request after the selected public application load balancer executes one or more load-balancing decisions and transmits the request to a particular service instance. Any of the service instances 216A, 216N could receive the request. At block 316, a service instance executes one or more data read operations and/or data write operations associated with the request using only virtual storage instance(s) within the region corresponding to the region identifier. The operations can be any API call, service invocation, method invocation, function execution, data CRUD operation, etc., that the service instance is programmed to perform to process and/or respond to the request in substance. In an embodiment, the fact the system interoperates with virtual storage instances does not mean that the virtual storage instances cannot exist solely within one particular geographic region. For example, commercially available public virtual computing services commonly assure customers that, when a program or process selects and uses a particular virtual storage instance, all the real digital data storage devices, such as hard disk drives, will be located in a physical data center in a particular named geographic region. Normally the virtual storage instances in these commercial cloud services have names or identifiers that connote or describe the geography in which they are located. Embodiments can use similar naming conventions to enforce data residency requirements; for example, a virtual storage instance denoted EU-WEST-1 will correspond to a commercial virtual storage instance, and underlying physical storage devices, that are guaranteed to be located within Western Europe or the western part of the European Union.

Block 316 depends in part upon each service instance being programmed to select a virtual storage instance only within the region specified in a request. Applications can use a common library to implement this logic. For example, each service instance or application can call methods of the same data update library, and those methods can implement secure logic to read the region identifier of a request or call and locate virtual storage instance(s) or other data storage devices only within the specified region. To support the execution of these methods, global hash map storage layers 236A, 238A can include tables that identify virtual storage instance(s) or storage device(s) that are within the same region as the service instance 216A. Similarly, at block 318, after executing a create, read, update, or delete operation, the virtual storage instance(s) implement replication to other storage instance(s) only within the region corresponding to the region identifier. In an embodiment, a service instance 316A can act as a controller to initiate replication via API calls into the virtual computing infrastructure, and global hash map storage layers 236A, 238A can comprise a table per group of regions that stores identifiers of other virtual storage instance(s) or data storage devices, thus providing information about where to replicate data.

At block 320, the service instance that received a request at block 314 optionally forwards the request to another service instance and includes a region identifier of the selected region in the forwarded request. For example, service instance 316A could receive a request originally and then call service 316N to execute a different or related operation. Block 320 broadly represents computer-implemented techniques for propagating data policy to other service instances or functional elements. In one embodiment, propagation can comprise the following specific steps:
1. The client transmits a request that includes a JSON Web Token (JWT token), which can include an access key; the request also includes a workspace identifier.
2. The edge processor validates the JWT token and queries a local cached data repository based on the workspace identifier and access key.
3. If a cache hit occurs, the edge processor retrieves organization configuration data and checks for a resolved Identity Access Management (IAM) policy that contains a regional load balancer identifier.
4. If a cache miss occurs, the edge processor determines which global hash map storage layer 230 is nearest, based on location data in an HTTP request that carried the client request or system region definitions that have been previously stored in edge processor memory.
5. If steps 3 and 4 do not yield an identifier of a regional load balancer, then return an error or exception. Otherwise, forward the client request to the regional load balancer that has been identified, with a copy of the organization configuration data in a new header.
6. Based on an API or request name or type specified in the request, the regional load balancer forwards the request to a service instance that can process the service represented in the request.

As described above for FIG. 2C, each service instance 216A, 216N can access both a global hash map storage layer 236A, 238A, respectively, and local hash map storage layers 236B, 238B, respectively. In the local hash map storage layers, a service stores data that does not need replication and the global hash map storage layers store data that needs replication. Based on the organization configuration data received in a forwarded request, a service instance can determine where to create, read, update, or delete data on a per-request level; the location of these CRUD operations can vary from request to request, with operations of successive requests occurring in virtual storage instances in completely different regions. Furthermore, each service instance 216A, 216N may communicate with another service through the internal application load balancer 122, which is within the same region; any such request includes the header described above to carry organization configuration data including a region identifier.

A benefit of the data policy declaration, control, and propagation approach described herein is that while a complete data policy for an organization could be detailed and verbose, each client request only needs to specify an organization, and forwarded requests only propagate a subset of the data policy, such as a region identifier or region group identifier. The entire data policy is not forwarded and can be referenced only once when the client request initially enters the service infrastructure. Consequently, organizations can specify a complex and detailed data residency policy, but enforcement of the policy is fast and efficient, using compact data items in forwarded requests. The use of a common function library to implement CRUD operations of service instances ensures consistent recognition and enforcement of region identifiers or region group identifiers.

### 2.3 Software-Defined Control of Programmatic Access to Services

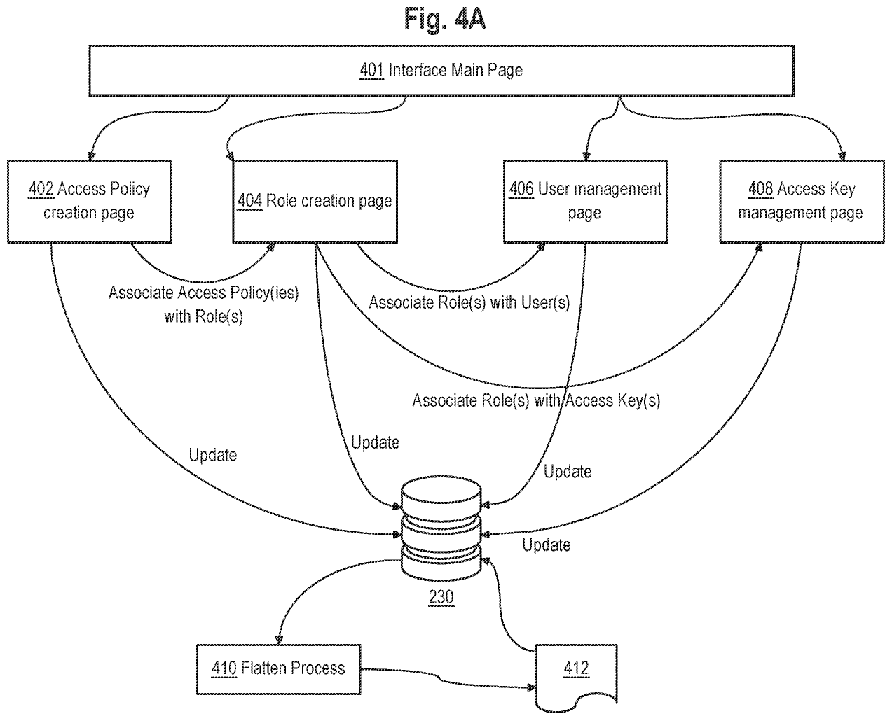

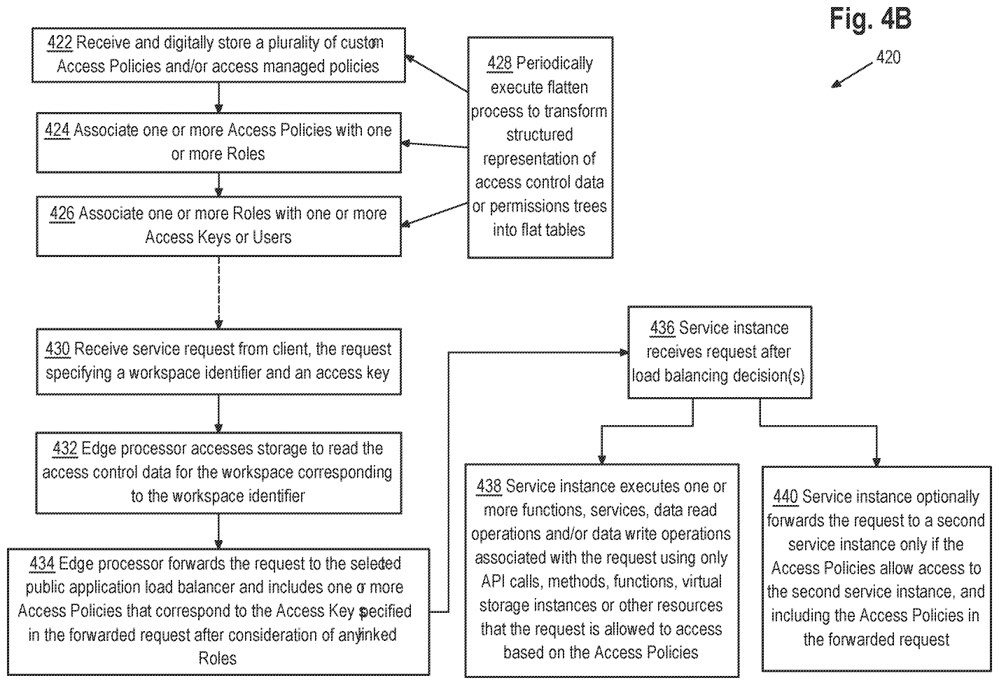

FIG. 4A illustrates an example data flow that can be used in one embodiment of defining distributed service access controls. FIG. 4B illustrates an example process flow that can be programmed to implement distributed service access control in a message processing system. In an embodiment, in general, distributed service access control in a message processing system uses access control declarations and propagations of access control data with requests in a manner similar to the techniques described in section 2.2 herein for data residency. In general, users or organizations can define policies to attach to roles to attach to users or API keys, and those policies propagate with requests to ensure that all service instances that process requests will control access based on the policies.

Referring first to FIG. 4A, in one embodiment, application 105 (FIG. 1) can be programmed with presentation and CRUD instructions to implement a SaaS-based administrative configuration interface that user computer 106 accesses using a browser. Alternatively, message application processor 110 and/or service instances 216A, 216N can implement the interface. In an embodiment, the instructions to implement the interface are programmed to generate and transmit presentation instructions to the user computer 106 which, when rendered and displayed using a browser, cause displaying interface main page 401 having links to an Access Policy creation page 402, Role creation page 404, User management page 406. Pages 402, 404, 406, 408 can be programmed to receive input data relating to access controls, and to digitally create, read, update, or delete records in global hash map storage layer 230, in the manner described herein in other sections. Access control data can be stored in a structured format such as JSON, YAML, or XML. A flatten process 410 can periodically execute to flatten complex structured representations of access controls into one or more flat database tables 412, each comprising rows representing access controls with column attributes corresponding to attributes of the structured representations.

As shown in FIG. 4B, in an embodiment, a process 420 of distributed service access control in a message processing system can be programmed at block 422 to receive and digitally store a plurality of custom access policies and/or access one or more managed policies. Custom access policies are access control definitions that individual users or organizations create and store in global hash map storage layer 230, and managed policies can be access control definitions that an owner, operator, or manager of a distributed system, acting as a service provider to customers, supplies “out of the box” in the global hash map storage layer for any organization with an account to use. In one embodiment, each of the custom Access Policies comprises at least a policy name, a resource identifier, and an action that is allowed or disallowed on the resource, each of the access policy definitions being associated with a first access key. Resource identifiers can identify resources in terms of all resources, or one or more API calls, methods, functions, virtual storage instances, or other resources that the request is allowed to access or disallowed to access.

Block 422 can comprise the user computer 106 interacting with the application 105 or message application processor 110 and the elements of FIG. 4A. In an embodiment, block 422 can be preceded by receiving input from user computer 106 to log in to the application server 104 and/or application 105, then to access the main page 401. In an embodiment, the main page 401 can be titled Organization Settings and can be programmed to present links to the following functions:
1. General. Change your organization's profile and appearance.
2. Users. Manage access of users in your organization.
3. Access Policies. Define the access policies, effects and resources limiting access control.
4. Teams. Add users to teams to manage what they have access to as a group.
5. Business Profile. Change your organization's legal business profile.
6. Plans & Billing. View and manage your pricing plans and billing settings.
7. Access Roles. Manage roles to be used for dashboard users and/or programmatic access.
8. Audit Logs. View which users performed with actions within your workspace.
9. Workspaces. Manage and edit your workspaces or create a new one.
10. Wallets. Manage balance across different wallets to use within workspaces.
11. Access Keys. Create and manage access keys for programmatic access to the APIs.

In an embodiment, block 422 can comprise receiving input from the user computer 106 to select Access Policy creation page 402 via option (3) above to create a custom policy. In response, application 105 can be programmed to access global hash map storage layer 230 to retrieve a set of existing Access Policies for an organization with which a user or the user computer 106 is associated. Application 105 can be programmed to output presentation instructions to display a representation of the existing Application Policies; one possible presentation could include:

| POLICY | DESCRIPTION | CREATED AT |
|---|---|---|
| Read only | Allows read only access to the | Dec. 07, 2021-07:14 PM |
| | organization | |
| Full API read/write | Allows full read/write access to all | Dec. 07, 2021-07:13 PM |
| | APIs | |
| Power application user | Selected application read/write | Dec. 07, 2021-07:11 PM |
| | access | |
| Full organization-wide read | Read and write access to all | Dec. 07, 2021-07:09 PM |
| and write access | resources | |

In an embodiment, block also can comprise receiving input from user computer 106 to select one of the policies in the display, or a link or button or UI widget denoted CREATE NEW, or an equivalent. In an embodiment, creating a custom policy comprises specifying a Policy Name, Policy Description, and one or more Definitions. Each Definition comprises an Effect, such as Allow; an Action, such as Any; and identifications of one or more Resources to which the definition applies. Each Resource can be identified via a resource path or network path and can include a character denoting a wildcard substitution, such as *. For example, a Resource could be “/workspace/contacts” thus referring to all contacts available in a workspace, or “/organization/*? Referring to all resources defined anywhere in the “organization” workspace. Examples of Actions include ANY, LIST, VIEW, CREATE, DELETE, and UPDATE. Data values are added to a JSON or other markup language structure that is digitally stored in the global hash map storage layer 230.

At block 424, the process can be programmed to receive input to associate one or more Access Policies with one or more Roles. In an embodiment, block 424 can comprise receiving input from the user computer 106 to select Role creation page 404 via option (7) above to create or update a Role. In response, application 105 can be programmed to access global hash map storage layer 230 to retrieve a set of existing Roles for an organization with which a user or the user computer 106 is associated. Application 105 can be programmed to output presentation instructions to display a representation of the existing Roles; one possible presentation could include:

| NAME | DESCRIPTION | CREATED AT |
|---|---|---|
| Automations manager | Has access to Flows | Dec. 07, 2021-07:09 PM |
| Support Agent | Has access to Inbox | Dec. 07, 2021-07:09 PM |
| Admin | Has full organization | Dec. 07, 2021-07:09 PM |
| | read/write access | |

In an embodiment, block 424 also can comprise receiving input from user computer 106 to select one of the Access Roles in the display, or a link or button or UI widget denoted CREATE NEW, or an equivalent. In an embodiment, creating an Access Role comprises accessing a creation page that prompts the user to enter General values and one or more Policy values. General values comprise a Role Name like “Support Agent,” and a Role Description like “Support agents have access to inbox.” Policy values comprise a Type and a Policy Identifier. Examples of Type include “Managed” and “Organization.” When the Type is Managed, the Policy identifier can specify a system-defined or pre-existing, fixed policy; the Managed option enables the use of default policies that do not require active user creation. When the Type is Organization, values for the Policy can be any of the custom policy names specified above, or that have been specified for the organization. Data values are persistently stored in the global hash map storage layer 230 in access role records. In this manner, a previously created organization-specific custom policy is bound to a rule.

At block 426, the process can be programmed to receive input to associate one or more Roles with one or more Access Keys or Users. In an embodiment, block 426 can comprise receiving input from the user computer 106 to select User management page 406 via option (2) to create or update a User, or to select Access Key management page 408 to create or update an Access Key. Assume that option (2) is selected to work with Users. In response, application 105 can be programmed to access global hash map storage layer 230 to retrieve a set of existing Users for an organization with which a user or the user computer 106 is associated. Application 105 can be programmed to output presentation instructions to display a representation of the existing Users; one possible presentation could include:

| DISPLAY | | | |
|---|---|---|---|
| NAME | ROLES | STATUS | CREATED AT |
| H.E. | Owner | Invited | Dec. 07, 2021-07:09 PM |
| Pennypacker | | | |
| Prof. Van | Owner | Active | Dec. 07, 2021-07:09 PM |
| Nostrand | | | |

In an embodiment, block 426 also can comprise receiving input from user computer 106 to select one of the Users in the display, or a link or button or UI widget denoted CREATE NEW, or an equivalent. In an embodiment, selecting a user generates and displays a Users Details page that shows input for a Display Name, email address, and one or more Roles. The Roles can be shown using a drop-down menu widget. The page can comprise an Add Role link which, when selected, causes generating a page that is programmed to accept input to specify a selection of a different previously defined Role. Similarly, one or more Roles can be bound to an Access Keys.

In an embodiment, selecting option (11), Access Keys, causes generating and displaying the Access Key management page 408, which can be programmed to retrieve from global hash map storage layer 230 and present a table of previously created Access Keys, such as:

| ROLE | DESCRIPTION | CREATED AT | LAST USED |
|---|---|---|---|
| Sandbox | Sandbox keys give full read/write access | Dec. 08, 2021 08:57 AM | Never |
| | to staging APIs | | |
| Staging | Staging keys give read access to | Dec. 08, 2021 08:57 AM | Two days ago |
| | staging APIs | | |
| Production | Production keys give full | Dec. 08, 2021 08:57 AM | Last week |
| | read/write access to production | | |
| | APIs | | |

In an embodiment, Access Key management page 408 further comprises an ADD NEW ACCESS KEY link which, when selected, enables adding a new key to storage for use in client requests or calls. Or, selecting an existing key like Staging from the table noted above causes generating and displaying an Access Keys data entry page that accepts a Key Name, Key Description, and Role. In an embodiment, specifying a Role can comprise selecting a Role pull-down widget that is populated with names of previously defined roles.

A selection of a particular Role and an UPDATE link can cause updating storage to associate the particular role with the then-current Access Key. As shown in FIG. 4A, interaction of user computer 106 with the Access Policy creation page 402 can create or update Access Policies; interaction with the Role creation page 404 can associate Access Policies with Roles; interaction with User management page 406 or Access Key management page 408 can associate Roles with Users or Access Keys, respectively. Any of the foregoing options, when data input from user computer 106 specifies an update or creating an item, causes updating global hash map storage layer 230.

All attributes specified above for Access Policies, Roles, Users, and Access Keys, and associations thereof, can be stored in global hash map storage layer 230 using one or more structured data items. For example, JSON, XML, or YAML files can specify structured representations of Access Policies, Roles, Users, and Access Keys, and associations thereof. When an organization is large, with many policies, roles, users, and keys, the size of these files will be large, sometimes requiring extensive processing to parse the files, build in-memory representations of text items in the files, and resolve wildcards. In an embodiment, as shown by block 428, process 420 is programmed to periodically execute a flatten process to transform the structured representation of the access control data into one or more flat data tables. For example, flatten process 410 can be configured as a CRON job or other scheduled job to execute nightly or weekly over access control data stored in global hash map storage layer 230 via the steps previously described for block 422, block 424, block 426. Or, the flatten process 410 can be configured using a database trigger at global hash map storage layer 230 to execute whenever a block 422, block 424, block 426 results in creating or updating a JSON blob in the global hash map storage layer for an element of access control data.

With the flatten process 410, the verbose representation of complex Access Policies and their associations to Roles, Users, and/or Access Keys in a structured form like JSON, XML, or YAML, can be flattened into an efficient storage representation. This approach precludes the need to parse structured files and resolve references at the time of a request. Fast database table lookups can use the workspace identifier as a key value in combination with a user identifier or user role value in the request to determine whether the request is allowed to execute.

In an embodiment, flatten process may include expanding wildcard expressions (for workspace for example, * workspace) into all permutations and updating the flattened table representation to include literals for them. Expansion of wildcards could limit to the boundaries of a user in an organization, that is, the expansion should not give a user access via wildcards to workspaces in a different organization.

From files comprising such structured representations, access control data can also be transformed for storage in one or more rows and columns of tables of a relational database; relationships of the rows and columns can form a permission tree. In an embodiment, the flatten process also triggers creating and storing a permission tree in the database. The permission tree is a relationship of column attributes and references among rows in a relational database table that represents the structured file representations without using a JSON, XML, or YAML blob in database storage. In an embodiment, a permission tree uses only literal references to resources and does not use wildcards. Thus, the resolution and flattening of wildcard references are used both to generate a flattened, searchable representation of the JSON and the permission tree. These processes can repeat when policies are created, updated, and when workspaces are refreshed.

At any time after access control data is created and stored in the global hash map storage layer, at block 430, the process is programmed to receive a service request from a client, the request specifying a workspace identifier and an access key. For example, client 202 (FIG. 2C) can transmit a request to an API endpoint that the cloud service entry point 204 proxies or virtualizes. In response, the cloud service entry point 204 forwards the request to the edge processor 234. As stated earlier, each request of client 202 includes at least a workspace identifier and an access key, and usually a request type or name and one or more parameters associated with the request. Client 202 transmits a Request to an API of the service provider; the Request includes a Workspace Identifier and an Access Key.

At block 432, the edge processor accesses storage to read the access control data for the workspace corresponding to the workspace identifier and Access Key in the request. For example, edge processor 234 executes a lookup in the global hash map storage layer 230 to determine whether the Access Key of the request is associated with a Role, whether the Access Policies of that Role authorize the request. Lookup operations at block 432 can execute against flattened tables representing access control data, rather than against the native structured representations. The effect of block 432 is to read, from global storage, one or more Access Policies or Roles that correspond to the Access Key specified in a request from a client. The workspace identifier serves as a primary key to limit lookups to records for the correct organization, and the Access Key constrains lookups to records for Access Policies of that organization that have been linked to or associated with the same Access Key via block 426, including consideration of any Roles that are linked to the Access Key and to Access Policies. That is, a lookup can comprise finding a matching Access Key in the global hash map storage layer; determining from the global hash map storage layer that the Access Key was bound to a Role; determining that the Role is bound to a particular Access Policy; and retrieving parameters for that Access Policy.

Block 432 can also include the operations of block 308, block 318 (FIG. 3) to select a region identified in a data policy for the workspace and to select a public application load balancer that is within a selected region.

At block 434, the edge processor forwards the request to the selected public application load balancer and includes the one or more Access Policies that correspond to the Access Key specified in the forwarded request and found via the lookup of block 432, after consideration of any Roles that are linked to the Access Key in the global hash map storage layer 230. The edge processor can use a new header for this purpose, append the parameters of the request, or append the data to a payload.

At block 436, like block 314 (FIG. 3), a Service instance receives a request after load balancing decision(s). At block 438, similar to block 316, a service instance executes one or more functions, services, data read operations, and/or data write operations using only virtual storage instance(s) that the request is allowed to access based on the Access Policies. In some embodiments, block 438 is programmed so the service instance executes one or more functions, services, data read operations and/or data write operations associated with the request using only API calls, methods, functions, virtual storage instances or other resources that the request is allowed to access based on the Access Policies. Thus, block 438 represents node-specific or instance-specific enforcement of an access policy. Examples of controls that a service instance enforces at block 438 can include invoking, or blocking invocation of, API calls, functions, or methods; executing CRUD operations with virtual storage instances, or blocking the execution of one or more of the CRUD operations (create, read, update, delete). If a client request specifies an API, call, function, or method that an Access Policy does not allow, then service instances can be programmed, at block 438, to return an error message, exception code, or other indication of an error.

At block 440, similar to block 320, a service instance optionally forwards the request to another service instance and includes the Access Policies in the forwarded request. Thus, service-to-service requests carry Access Policies in forwarded requests to ensure that downstream nodes enforce the Access Policies. Consistent enforcement can be achieved by using a common method or function call library to implement methods to read Access Policies and decide whether to allow or block a particular method and programming every service instance to invoke the common library before executing a client request.

A benefit of this approach is that the use of an Access Key is limited both to an API and to a user Role. Since defining Access Policies and Roles offers high flexibility, the combination of those items with an Access Key enables tremendous flexibility in controlling the use of available services.

### 2.4 Practical Applications

The embodiments of this disclosure can be applied to many practical situations of data processing, communications, or interoperation with other systems. Embodiments provide a flexible, accessible means of defining data residency requirements, enabling the use of human-readable declarations of data residency requirements with efficient transformation into machine-readable formats that can be read and evaluated at wire speed as messages traverse the system. The use of a common code library to implement data residency checks ensures that all services operate consistently. Programming all services to forward data policies from service to service ensures consistent operation across the system, and enables a user or organization to define a data policy once with the implicit assurance that the policy will be enforced across a complex system.

Access control policy can be defined and propagated across the system in a similar manner. Binding an access policy to an access key provides an efficient means for service instances to look up the correct access policy. Flattening access policies into permissions trees in relational databases, or flat files that resemble spreadsheets, enables users or organizations to use human-readable structured declarations to define complex access policies once, then transform complex or verbose policies into forms of storage that are amenable to fast, wire-speed lookups and evaluation at any service node. The use of a common code library to implement access policy checks ensures that all services operate consistently. Programming all services to forward access policies from service to service ensures consistent operation across the system, and enables a user or organization to define an access policy once with the implicit assurance that the policy will be enforced across a complex system.

### 3. Implementation Example—Hardware Overview

According to one embodiment, the techniques described herein are implemented by at least one computing device. The techniques may be implemented in whole or in part using a combination of at least one server computer and/or other computing devices that are coupled using a network, such as a packet data network. The computing devices may be hard-wired to perform the techniques or may include digital electronic devices such as at least one application-specific integrated circuit (ASIC) or field programmable gate array (FPGA) that is persistently programmed to perform the techniques or may include at least one general purpose hardware processor programmed to perform the techniques pursuant to program instructions in firmware, memory, other storage, or a combination. Such computing devices may also combine custom hard-wired logic, ASICs, or FPGAs with custom programming to accomplish the described techniques. The computing devices may be server computers, workstations, personal computers, portable computer systems, handheld devices, mobile computing devices, wearable devices, body-mounted or implantable devices, smartphones, smart appliances, internetworking devices, autonomous or semi-autonomous devices such as robots or unmanned ground or aerial vehicles, any other electronic device that incorporates hard-wired and/or program logic to implement the described techniques, one or more virtual computing machines or instances in a data center, and/or a network of server computers and/or personal computers.

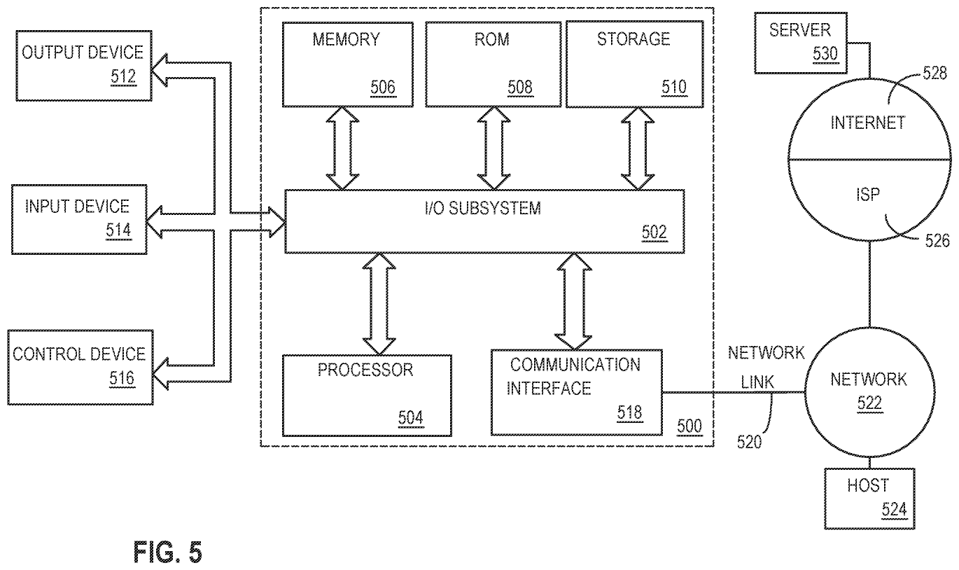

FIG. 5 is a block diagram that illustrates an example computer system with which an embodiment may be implemented. In the example of FIG. 5, a computer system 500 and instructions for implementing the disclosed technologies in hardware, software, or a combination of hardware and software, are represented schematically, for example as boxes and circles, at the same level of detail that is commonly used by persons of ordinary skill in the art to which this disclosure pertains for communicating about computer architecture and computer systems implementations.

Computer system 500 includes an input/output (I/O) subsystem 502 which may include a bus and/or other communication mechanism(s) for communicating information and/or instructions between the components of the computer system 500 over electronic signal paths. The I/O subsystem 502 may include an I/O controller, a memory controller, and at least one I/O port. The electronic signal paths are represented schematically in the drawings, for example as lines, unidirectional arrows, or bidirectional arrows.

At least one hardware processor 504 is coupled to I/O subsystem 502 for processing information and instructions. Hardware processor 504 may include, for example, a general-purpose microprocessor or microcontroller and/or a special-purpose microprocessor such as an embedded system, a graphics processing unit (GPU), or a digital signal processor or ARM processor. Processor 504 may comprise an integrated arithmetic logic unit (ALU) or may be coupled to a separate ALU.

Computer system 500 includes one or more units of memory 506, such as a main memory, which is coupled to I/O subsystem 502 for electronically digitally storing data and instructions to be executed by processor 504. Memory 506 may include volatile memory such as various forms of random-access memory (RAM) or other dynamic storage device. Memory 506 may also be used for storing temporary variables or other intermediate information during the execution of instructions to be executed by processor 504. Such instructions, when stored in non-transitory computer-readable storage media accessible to processor 504, can render computer system 500 into a special-purpose machine that is customized to perform the operations specified in the instructions.

Computer system 500 further includes non-volatile memory such as read only memory (ROM) 508 or other static storage device coupled to I/O subsystem 502 for storing information and instructions for processor 504. The ROM 508 may include various forms of programmable ROM (PROM) such as erasable PROM (EPROM) or electrically erasable PROM (EEPROM). A unit of persistent storage 510 may include various forms of non-volatile RAM (NVRAM), such as FLASH memory, or solid-state storage, magnetic disk or optical disk such as CD-ROM or DVD-ROM and may be coupled to I/O subsystem 502 for storing information and instructions. Storage 510 is an example of a non-transitory computer-readable medium that may be used to store instructions and data which when executed by the processor 504 cause performing computer-implemented methods to execute the techniques herein.

The instructions in memory 506, ROM 508, or storage 510 may comprise one or more sets of instructions that are organized as modules, methods, objects, functions, routines, or calls. The instructions may be organized as one or more computer programs, operating system services, or application programs including mobile apps. The instructions may comprise an operating system and/or system software; one or more libraries to support multimedia, programming, or other functions; data protocol instructions or stacks to implement TCP/IP, HTTP or other communication protocols; file format processing instructions to parse or render files coded using HTML, XML, JPEG, MPEG or PNG; user interface instructions to render or interpret commands for a graphical user interface (GUI), command-line interface or text user interface; application software such as an office suite, internet access applications, design and manufacturing applications, graphics applications, audio applications, software engineering applications, educational applications, games or miscellaneous applications. The instructions may implement a web server, web application server, or web client. The instructions may be organized as a presentation layer, application layer, and data storage layer such as a relational database system using structured query language (SQL) or no SQL, an object store, a graph database, a flat file system, or other data storage.

Computer system 500 may be coupled via I/O subsystem 502 to at least one output device 512. In one embodiment, output device 512 is a digital computer display. Examples of a display that may be used in various embodiments include a touch screen display or a light-emitting diode (LED) display or a liquid crystal display (LCD) or an e-paper display. Computer system 500 may include other type(s) of output devices 512, alternatively or in addition to a display device. Examples of other output devices 512 include printers, ticket printers, plotters, projectors, sound cards or video cards, speakers, buzzers or piezoelectric devices or other audible devices, lamps or LED or LCD indicators, haptic devices, actuators or servos.

At least one input device 514 is coupled to I/O subsystem 502 for communicating signals, data, command selections or gestures to processor 504. Examples of input devices 514 include touch screens, microphones, still and video digital cameras, alphanumeric and other keys, keypads, keyboards, graphics tablets, image scanners, joysticks, clocks, switches, buttons, dials, slides, and/or various types of sensors such as force sensors, motion sensors, heat sensors, accelerometers, gyroscopes, and inertial measurement unit (IMU) sensors and/or various types of transceivers such as wireless, such as cellular or Wi-Fi, radio frequency (RF) or infrared (IR) transceivers and Global Positioning System (GPS) transceivers.

Another type of input device is a control device 516, which may perform cursor control or other automated control functions such as navigation in a graphical interface on a display screen, alternatively or in addition to input functions. Control device 516 may be a touchpad, a mouse, a trackball, or cursor direction keys for communicating direction information and command selections to processor 504 and for controlling cursor movement on display 512. The input device may have at least two degrees of freedom in two axes, a first axis (e.g., x) and a second axis (e.g., y), that allows the device to specify positions in a plane. Another type of input device is a wired, wireless, or optical control device such as a joystick, wand, console, steering wheel, pedal, gearshift mechanism, or other type of control device. An input device 514 may include a combination of multiple different input devices, such as a video camera and a depth sensor.

In another embodiment, computer system 500 may comprise an Internet of Things (IoT) device in which one or more of the output device 512, input device 514, and control device 516 are omitted. Or, in such an embodiment, the input device 514 may comprise one or more cameras, motion detectors, thermometers, microphones, seismic detectors, other sensors or detectors, measurement devices or encoders and the output device 512 may comprise a special-purpose display such as a single-line LED or LCD display, one or more indicators, a display panel, a meter, a valve, a solenoid, an actuator or a servo.

When computer system 500 is a mobile computing device, input device 514 may comprise a global positioning system (GPS) receiver coupled to a GPS module that is capable of triangulating to a plurality of GPS satellites, determining and generating geo-location or position data such as latitude-longitude values for a geophysical location of the computer system 500. Output device 512 may include hardware, software, firmware and interfaces for generating position reporting packets, notifications, pulse or heartbeat signals, or other recurring data transmissions that specify a position of the computer system 500, alone or in combination with other application-specific data, directed toward host 524 or server 530.

Computer system 500 may implement the techniques described herein using customized hard-wired logic, at least one ASIC or FPGA, firmware and/or program instructions or logic which when loaded and used or executed in combination with the computer system causes or programs the computer system to operate as a special-purpose machine. According to one embodiment, the techniques herein are performed by computer system 500 in response to processor 504 executing at least one sequence of at least one instruction contained in main memory 506. Such instructions may be read into main memory 506 from another storage medium, such as storage 510. Execution of the sequences of instructions contained in main memory 506 causes processor 504 to perform the process steps described herein. In alternative embodiments, hard-wired circuitry may be used in place of or in combination with software instructions.

The term “storage media” as used herein refers to any non-transitory media that store data and/or instructions that cause a machine to operate in a specific fashion. Such storage media may comprise non-volatile media and/or volatile media. Non-volatile media includes, for example, optical or magnetic disks, such as storage 510. Volatile media includes dynamic memory, such as memory 506. Common forms of storage media include, for example, a hard disk, solid state drive, flash drive, magnetic data storage medium, any optical or physical data storage medium, memory chip, or the like.

Storage media is distinct from but may be used in conjunction with transmission media. Transmission media participates in transferring information between storage media. For example, transmission media includes coaxial cables, copper wire, and fiber optics, including the wires that comprise a bus of I/O subsystem 502. Transmission media can also take the form of acoustic or light waves, such as those generated during radio-wave and infra-red data communications.

Various forms of media may be involved in carrying at least one sequence of at least one instruction to processor 504 for execution. For example, the instructions may initially be carried on a magnetic disk or solid-state drive of a remote computer. The remote computer can load the instructions into its dynamic memory and send the instructions over a communication link such as a fiber optic or coaxial cable or telephone line using a modem. A modem or router local to computer system 500 can receive the data on the communication link and convert the data to a format that can be read by computer system 500. For instance, a receiver such as a radio frequency antenna or an infrared detector can receive the data carried in a wireless or optical signal and appropriate circuitry can provide the data to I/O subsystem 502 such as place the data on a bus. I/O subsystem 502 carries the data to memory 506, from which processor 504 retrieves and executes the instructions. The instructions received by memory 506 may optionally be stored on storage 510 either before or after execution by processor 504.

Computer system 500 also includes a communication interface 518 coupled to bus 502. Communication interface 518 provides a two-way data communication coupling to network link(s) 520 that are directly or indirectly connected to at least one communication network, such as a network 522 or a public or private cloud on the Internet. For example, communication interface 518 may be an Ethernet networking interface, integrated-services digital network (ISDN) card, cable modem, satellite modem, or a modem to provide a data communication connection to a corresponding type of communications line, for example, an Ethernet cable or a metal cable of any kind or a fiber-optic line or a telephone line. Network 522 broadly represents a local area network (LAN), wide-area network (WAN), campus network, internetwork, or any combination thereof. Communication interface 518 may comprise a LAN card to provide a data communication connection to a compatible LAN, or a cellular radiotelephone interface that is wired to send or receive cellular data according to cellular radiotelephone wireless networking standards, or a satellite radio interface that is wired to send or receive digital data according to satellite wireless networking standards. In any such implementation, communication interface 518 sends and receives electrical, electromagnetic, or optical signals over signal paths that carry digital data streams representing various types of information.

Network link 520 typically provides electrical, electromagnetic, or optical data communication directly or through at least one network to other data devices, using, for example, satellite, cellular, Wi-Fi, or BLUETOOTH technology. For example, network link 520 may provide a connection through a network 522 to a host computer 524.

Furthermore, network link 520 may provide a connection through network 522 or to other computing devices via internetworking devices and/or computers that are operated by an Internet Service Provider (ISP) 526. ISP 526 provides data communication services through a world-wide packet data communication network represented as internet 528. A server computer 530 may be coupled to internet 528. Server 530 broadly represents any computer, data center, virtual machine or virtual computing instance with or without a hypervisor, or computer executing a containerized program system such as DOCKER or KUBERNETES. Server 530 may represent an electronic digital service that is implemented using more than one computer or instance and that is accessed and used by transmitting web services requests, uniform resource locator (URL) strings with parameters in HTTP payloads, API calls, app services calls, or other service calls. Computer system 500 and server 530 may form elements of a distributed computing system that includes other computers, a processing cluster, a server farm, or other organization of computers that cooperate to perform tasks or execute applications or services. Server 530 may comprise one or more sets of instructions that are organized as modules, methods, objects, functions, routines, or calls. The instructions may be organized as one or more computer programs, operating system services, or application programs including mobile apps. The instructions may comprise an operating system and/or system software; one or more libraries to support multimedia, programming, or other functions; data protocol instructions or stacks to implement TCP/IP, HTTP or other communication protocols; file format processing instructions to parse or render files coded using HTML, XML, JPEG, MPEG or PNG; user interface instructions to render or interpret commands for a graphical user interface (GUI), command-line interface or text user interface; application software such as an office suite, internet access applications, design and manufacturing applications, graphics applications, audio applications, software engineering applications, educational applications, games or miscellaneous applications. Server 530 may comprise a web application server that hosts a presentation layer, application layer and data storage layer such as a relational database system using structured query language (SQL) or no SQL, an object store, a graph database, a flat file system or other data storage.

Computer system 500 can send messages and receive data and instructions, including program code, through the network(s), network link 520 and communication interface 518. In the Internet example, a server 530 might transmit a requested code for an application program through Internet 528, ISP 526, local network 522 and communication interface 518. The received code may be executed by processor 504 as it is received, and/or stored in storage 510, or other non-volatile storage for later execution.

The execution of instructions as described in this section may implement a process in the form of an instance of a computer program that is being executed, and consisting of program code and its current activity. Depending on the operating system (OS), a process may be made up of multiple threads of execution that execute instructions concurrently. In this context, a computer program is a passive collection of instructions, while a process may be the actual execution of those instructions. Several processes may be associated with the same program; for example, opening up several instances of the same program often means more than one process is being executed. Multitasking may be implemented to allow multiple processes to share processor 504. While each processor 504 or core of the processor executes a single task at a time, computer system 500 may be programmed to implement multitasking to allow each processor to switch between tasks that are being executed without having to wait for each task to finish. In an embodiment, switches may be performed when tasks perform input/output operations when a task indicates that it can be switched, or on hardware interrupts. Time-sharing may be implemented to allow fast response for interactive user applications by rapidly performing context switches to provide the appearance of concurrent execution of multiple processes simultaneously. In an embodiment, for security and reliability, an operating system may prevent direct communication between independent processes, providing strictly mediated and controlled inter-process communication functionality.

In the foregoing specification, embodiments of the invention have been described with reference to numerous specific details that may vary from implementation to implementation. The specification and drawings are, accordingly, to be regarded in an illustrative rather than a restrictive sense. The sole and exclusive indicator of the scope of the invention, and what is intended by the applicants to be the scope of the invention, is the literal and equivalent scope of the set of claims that issue from this application, in the specific form in which such claims issue, including any subsequent correction.

What is claimed is:

1. A computer-implemented method, comprising:
using a message processing system, receiving and digitally storing a plurality of structured service access policy definitions that correspond to data policies, each of the service access policy definitions comprising at least a policy name, a resource identifier, and an action that is allowed or disallowed on the resource, each of the access policy definitions being associated with a first access key, each of the service access policy definitions being stored in a virtual storage instance;
using the message processing system, receiving a service request from a client computer, the service request comprising a second access key, and in response to the request, the message processing system accessing the virtual storage instance to read a particular service access policy corresponding to the second access key;
the message processing system forwarding the service request to a service instance only when the particular service access policy corresponding to the second access key of the service request allows the client computer or a user thereof to access the service instance.

2. The method of claim 1, further comprising storing the plurality of structured service access policy definitions in a first global hash map storage layer of the virtual storage instance.

3. The method of claim 2, the message processing system comprising at least an edge processor, a public application load balancer that is communicatively coupled to the edge processor and to a plurality of service instances, each of the service instances being hosted or executed using a virtual compute instance, each of the service instances being communicatively coupled to a second global hash map storage layer and a local hash map storage layer, the first global hash map storage layer being communicatively coupled to the edge processor;
the method further comprising:
receiving the service request from the client computer at the edge processor;
the edge processor reading the particular service access policy corresponding to the second workspace identifier from the first global hash map storage layer;
the edge processor forwarding the service request to the public application load balancer with a new header comprising the particular service access policy corresponding to the second workspace identifier.

4. The method of claim 1, each of the service access policy definitions comprising at least a policy name, a resource identifier, and an action that is allowed or disallowed on one or more API calls, methods, functions, virtual storage instances or other resources.

5. The method of claim 3, each of the service access policy definitions comprising at least a policy name, a resource identifier, and an action that is allowed or disallowed on one or more API calls, methods, functions, virtual storage instances or other resources.

6. The method of claim 5, further comprising a first service instance among the plurality of service instances executing one or more functions, services, data read operations and/or data write operations associated with the request using only API calls, methods, functions, virtual storage instances or other resources that the client computer or a user thereof is allowed to access based on the particular service access policy.

7. The method of claim 5, further comprising a first service instance among the plurality of service instances forwarding the request to a second service instance among the plurality of service instances, as a forwarded request, only when the particular service access policy corresponding to the second access key of the service request allows the client computer or a user thereof to access the second service instance, and including the particular service access policy in the forwarded request.

8. The method of claim 7, further comprising the message processing system selecting, from the particular service access policy, the particular region identifier of the particular geographic region based on the priority value of the particular geographic region.

9. The method of claim 6, further comprising, as part of the executing, selecting a particular communication channel among a plurality of different communication channels, and transmitting a request to the particular communication channel to transmit a message using the particular communication channel.

10. The method of claim 9, the plurality of different communication channels comprising two or more of SMS; MMS; WHATSAPP; FACEBOOK MESSENGER; WEIXIN/WECHAT; QQ; TELEGRAM; SNAPCHAT; SLACK; SIGNAL; SKYPE; DISCORD; VIBER.

11. One or more non-transitory computer-readable storage media storing one or more sequences of instructions which, when executed using one or more hardware processors of a message application processor cause the message application processor to perform:
using a message processing system, receiving and digitally storing a plurality of structured service access policy definitions that correspond to data policies, each of the service access policy definitions comprising at least a policy name, a resource identifier, and an action that is allowed or disallowed on the resource, each of the access policy definitions being associated with a first access key, each of the service access policy definitions being stored in a virtual storage instance;
using the message processing system, receiving a service request from a client computer, the service request comprising a second access key, and in response to the request, the message processing system accessing the virtual storage instance to read a particular service access policy corresponding to the second access key;
the message processing system forwarding the service request to a service instance only when the particular service access policy corresponding to the second access key of the service request allows the client computer or a user thereof to access the service instance.

12. The one or more non-transitory computer-readable storage media of claim 11, further comprising sequences of instructions which, when executed using one or more hardware processors of a message application processor cause the message application processor to perform storing the plurality of structured service access policy definitions in a first global hash map storage layer of the virtual storage instance.

13. The one or more non-transitory computer-readable storage media of claim 12, the message processing system comprising at least an edge processor, a public application load balancer that is communicatively coupled to the edge processor and to a plurality of service instances, each of the service instances being hosted or executed using a virtual compute instance, each of the service instances being communicatively coupled to a second global hash map storage layer and a local hash map storage layer, the first global hash map storage layer being communicatively coupled to the edge processor;
the method further comprising sequences of instructions which, when executed using one or more hardware processors of a message application processor cause the message application processor to perform:
receiving the service request from the client computer at the edge processor;
the edge processor reading the particular service access policy corresponding to the second workspace identifier from the first global hash map storage layer;
the edge processor forwarding the service request to the public application load balancer with a new header comprising the particular service access policy corresponding to the second workspace identifier.

14. The one or more non-transitory computer-readable storage media of claim 11, each of the service access policy definitions comprising at least a policy name, a resource identifier, and an action that is allowed or disallowed on one or more API calls, methods, functions, virtual storage instances or other resources.

15. The one or more non-transitory computer-readable storage media of claim 13, each of the service access policy definitions comprising at least a policy name, a resource identifier, and an action that is allowed or disallowed on one or more API calls, methods, functions, virtual storage instances or other resources.

16. The one or more non-transitory computer-readable storage media of claim 15, further comprising sequences of instructions which, when executed using one or more hardware processors of a message application processor cause the message application processor to perform a first service instance among the plurality of service instances executing one or more functions, services, data read operations and/or data write operations associated with the request using only API calls, methods, functions, virtual storage instances or other resources that the client computer or a user thereof is allowed to access based on the particular service access policy.

17. The one or more non-transitory computer-readable storage media of claim 15, further comprising sequences of instructions which, when executed using one or more hardware processors of a message application processor cause the message application processor to perform a first service instance among the plurality of service instances forwarding the request to a second service instance among the plurality of service instances, as a forwarded request, only when the particular service access policy corresponding to the second access key of the service request allows the client computer or a user thereof to access the second service instance, and including the particular service access policy in the forwarded request.

18. The one or more non-transitory computer-readable storage media of claim 17, further comprising sequences of instructions which, when executed using one or more hardware processors of a message application processor cause the message application processor to perform the message processing system selecting, from the particular service access policy, the particular region identifier of the particular geographic region based on the priority value of the particular geographic region.

19. The one or more non-transitory computer-readable storage media of claim 16, further comprising sequences of instructions which, when executed using one or more hardware processors of a message application processor cause the message application processor to perform, as part of the executing, selecting a particular communication channel among a plurality of different communication channels, and transmitting a request to the particular communication channel to transmit a message using the particular communication channel.

20. The one or more non-transitory computer-readable storage media of claim 19, the plurality of different communication channels comprising two or more of SMS; MMS; WHATSAPP; FACEBOOK MESSENGER; WEIXIN/WECHAT; QQ; TELEGRAM; SNAPCHAT; SLACK; SIGNAL; SKYPE; DISCORD; VIBER.
